(19) United States
(12) Patent Application Publication
(10) Pub. No.: US 2024/0309702 A1
(43) Pub. Date: Sep. 19, 2024

(54) SINGLE-SPAN LADDER WITH STEPS AND ANTI-SLIDE BASE

(71) Applicant: Samantha Narelle Kirkland, Franklin, NC (US)

(72) Inventor: Samantha Narelle Kirkland, Franklin, NC (US)

(21) Appl. No.: 18/600,143

(22) Filed: Mar. 8, 2024

Related U.S. Application Data
(60) Provisional application No. 63/452,585, filed on Mar. 16, 2023.

(51) Int. Cl. E06C 7/46; E06C 1/06; E06C 7/08

(52) U.S. Cl. CPC E06C 7/46; E06C 1/06; E06C 7/08; E06C 7/082

(57) ABSTRACT

A ladder includes a first rail and a second rail spaced apart and parallel to one another. The ladder includes a plurality of rungs coupled between the first rail and the second rail. The plurality of rungs is spaced a distance apart along a length of the first rail and the second rail. The ladder includes an anti-slip footing removably coupled to a proximal end of the first rail and a proximal end of the second rail. The anti-slip base includes a base, a first side support coupled to a first side of the base, and a second side support coupled to a second side of the base opposite the first side of the base. The first side support and the second side support inhibit the first rail and the second rail sliding. The anti-slip footing is configured to move relative to the first rail and the second rail.

### CROSS-REFERENCE TO RELATED APPLICATIONS

This application claims the benefit of priority of U.S. provisional application No. 63/452,585, filed Mar. 16, 2023, entitled “Single Span Carbon Fiber Ladder with Steps,” the entire contents of which are herein incorporated by reference.

### FIELD

The present disclosure relates to ladders.

### BACKGROUND

Standard ladders provide little or no protection for the ladder slipping from its position. This can cause falls and potentially serious injury to the user of the ladder. Moreover, the standard ladders are difficult to carry and erect.

As can be seen, there is a need for improved ladders that address the above drawbacks.

### SUMMARY

In one aspect of the present disclosure, a ladder includes a first rail and a second rail spaced apart and parallel to one another. The ladder includes a plurality of rungs coupled between the first rail and the second rail. Each of the plurality of rungs is spaced a distance apart along a length of the first rail and the second rail. The ladder includes an anti-slip footing removably coupled to a proximal end of the first rail and a proximal end of the second rail. The anti-slip base includes a base, a first side support coupled to a first side of the base, and a second side support coupled to a second side of the base opposite the first side of the base. The first side support and the second side support inhibit the first rail and the second rail, respectively, from sliding laterally. The anti-slip footing is configured to move relative to the first rail and the second rail.

### BRIEF DESCRIPTION OF THE DRAWINGS

FIG. 1 is a front view of a ladder, according to aspects of the present disclosure;

FIG. 2A is a rear view of the ladder of FIG. 1, according to aspects of the present disclosure;

FIG. 2B is an enlarged rear view of a top section of the ladder of FIG. 1, according to aspects of the present disclosure;

FIGS. 3A-3E are cross-sectional views of various configurations of rungs used in the ladder of FIG. 1, according to aspects of the present disclosure;

FIG. 4 is an elevated, exploded view of the anti-slip footing of the ladder of FIG. 1, according to aspects of the present disclosure; and

FIG. 5 is a method of manufacturing the ladder of FIG. 1, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As discussed above, standard ladders are susceptible to slipping, which can cause injury to the user. Broadly, an embodiment of the present disclosure provides a lightweight ladder that includes an anti-slip footing to prevent the ladder from moving and/or sliding laterally or longitudinally.

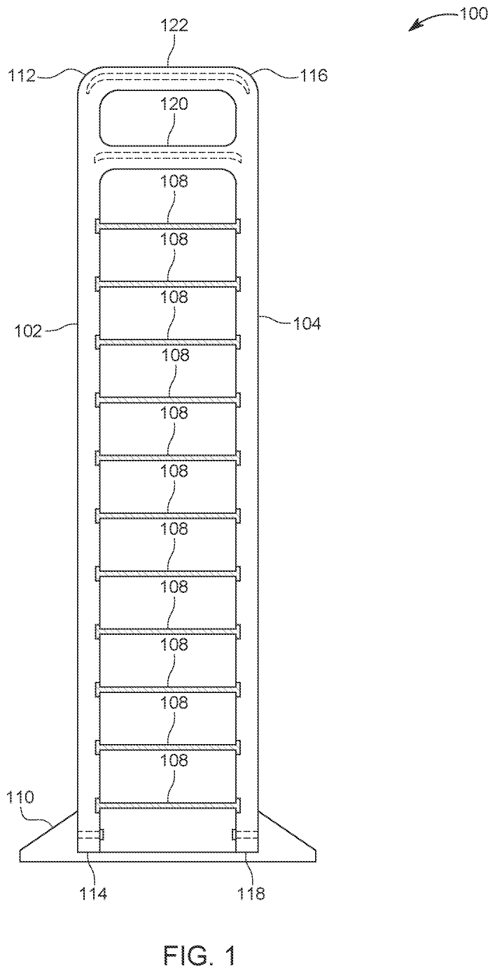

Referring now to FIGS. 1, 2A, 2B, 3A-3E, and 4, FIG. 1 illustrates a ladder 100, according to aspects of the present disclosure. While FIG. 1 illustrates examples of components of the ladder 100, additional components can be added and existing components can be removed and/or modified.

As illustrated in FIG. 1, the ladder 100 includes a first rail 102 and a second rail 104. The first rail 102 and the second rail 104 are positioned approximately parallel to one another. The ladder 100 includes rungs 108 that are coupled between the first rail 102 and the second rail 104. The ladder 100 includes an anti-slip footing 108 removably coupled to a lower portion of the first rail 102 and the second rail 104. In some embodiments, the first rail 102 and the second rail 104 can have an approximately rectangular cross-sectional shape. In some embodiments, the first rail 102 and the second rail 104 can be formed of carbon fiber.

Each rung 108 can be coupled between the first rail 102 and the second rail 104. Each rung 108 can be coupled to the first rail 102 such that the rungs 108 are approximately perpendicular to a long axis, extending from a proximal end 114 of the first rail 102 to a distal end 112 of the first rail 102. Each rung 108 can be coupled to the second rail 104 such that the rungs 108 are approximately perpendicular to a long axis, extending from a proximal end 118 of the second rail 104 to a distal end 116 of the second rail 104. In some embodiments, the rungs 108 can have an approximately rectangular cross-sectional shape. In some embodiments, the rungs 108 can be formed of carbon fiber.

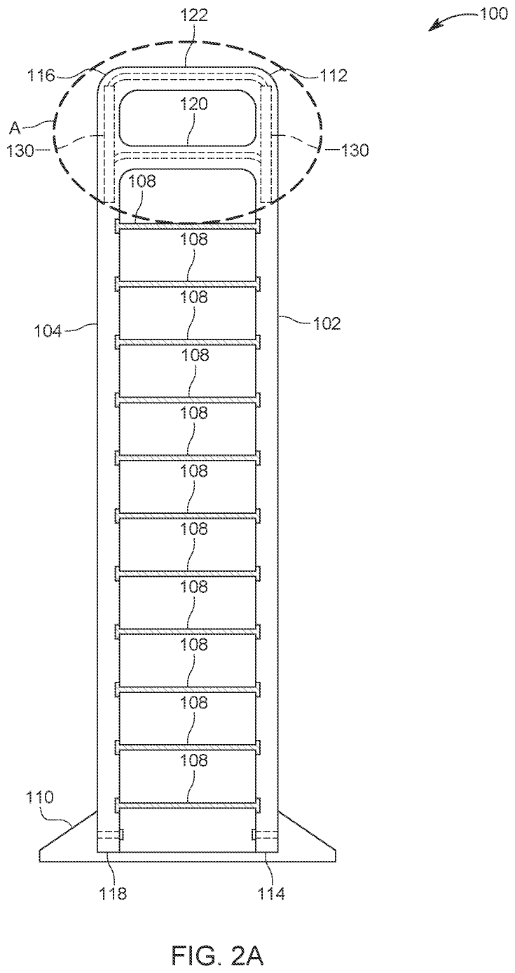

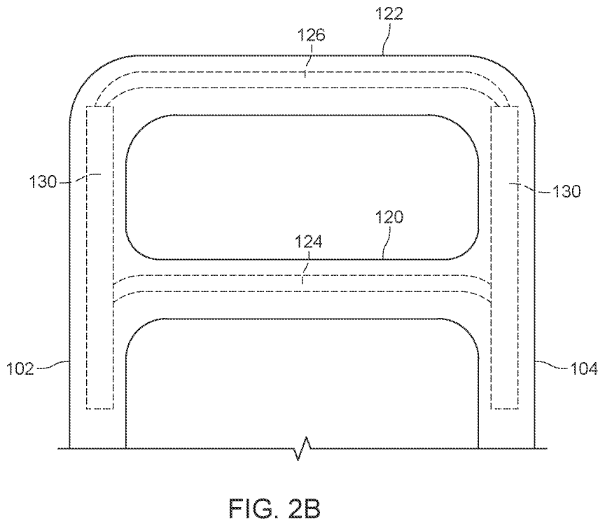

In some embodiments, the ladder 100 can include a penultimate rung 120 and a top rung 122. The penultimate rung 120 can be positioned adjacent to the distal end 112 of the first rail 102 and the distal end 116 of the second rail 104. For example, the penultimate rung 120 can operate as the next to last rung in the series of rung 108 extending along the long axis of the first rail 102 and along the long axis of the second rail 104. In some embodiments, as illustrated in FIG. 2B, the penultimate rung 120 can include a rounded surface or portion 124 formed on a top surface of the penultimate rung 120. The rounded surface 124 can indicate or warn the user of ladder 100 that the top of the ladder is near when the user steps on or grasps the penultimate rung 120. In some embodiments, the penultimate rung 120 can be formed of carbon fiber.

The top rung 122 can be positioned at the distal end 112 of the first rail 102 and the distal end 116 of the second rail 104. For example, the top rung 122 can operate as the last rung in the series of rung 108 and the penultimate rung 120 extending along the long axis of the first rail 102 and along the long axis of the second rail 104. In some embodiments, the top rung 122 can include a rounded surface or portion 126 formed on a top surface of the top rung 122. The rounded surface 126 can indicate or warn the user of ladder 100 that the top of the ladder is near when the user steps on or grasps the top rung 122. In some embodiments, the top rung 122 can be formed of carbon fiber.

As illustrated in FIGS. 2A and 2B, which show a rear side of the ladder 100, the first rail 102 can include an anti-slide strip 130 formed on a rear surface of the first rail 102 adjacent to the distal end 112. Likewise, the second rail 104 can include an anti-slide strip 130 formed on a rear surface of the second rail 104 adjacent to the distal end 116. The anti-slide strip 132 can be formed as a rectangular strip that includes an adhesive side for adhering to the first rail 102 and the second rail 104 and a textured side that provides a gripping surface. The anti-side strip 132 can inhibit the ladder from sliding off a surface when a distal end of the ladder is placed against the surface, e.g., a roof, tree, gutter, etc.

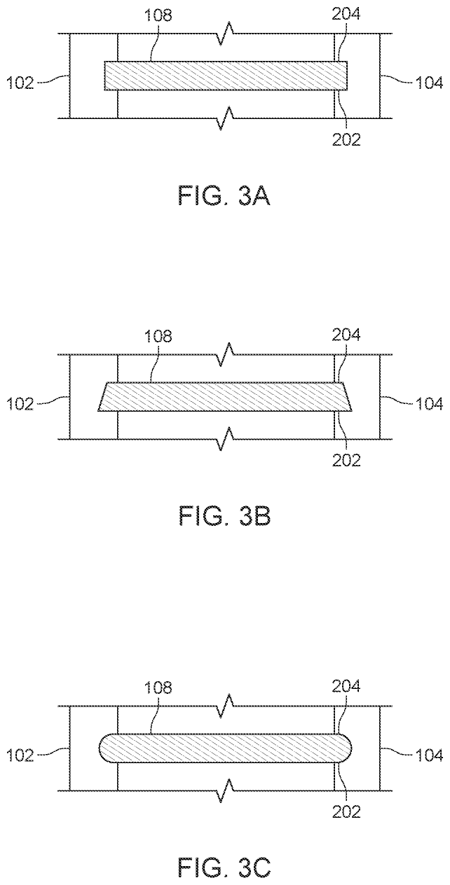

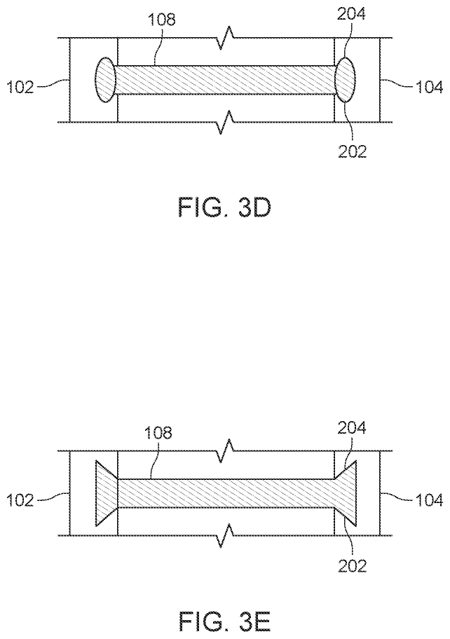

As illustrated in FIGS. 3A-3E, which show various configurations of the rungs 108, the first rail 102 and the second rail 104 can each include a rung slot 202 for receiving a rung attachment end 204. The rung slot 202 can be formed to match the shape and size of the rung attachment end 204. The rung attachment end 204 can have various shapes such as a flat shape (FIG. 3A, a slanted shape (FIG. 3B), a rounded shape (FIG. 3C), a lobe shape (FIG. 3D), and a polygon shape (FIG. 3E).

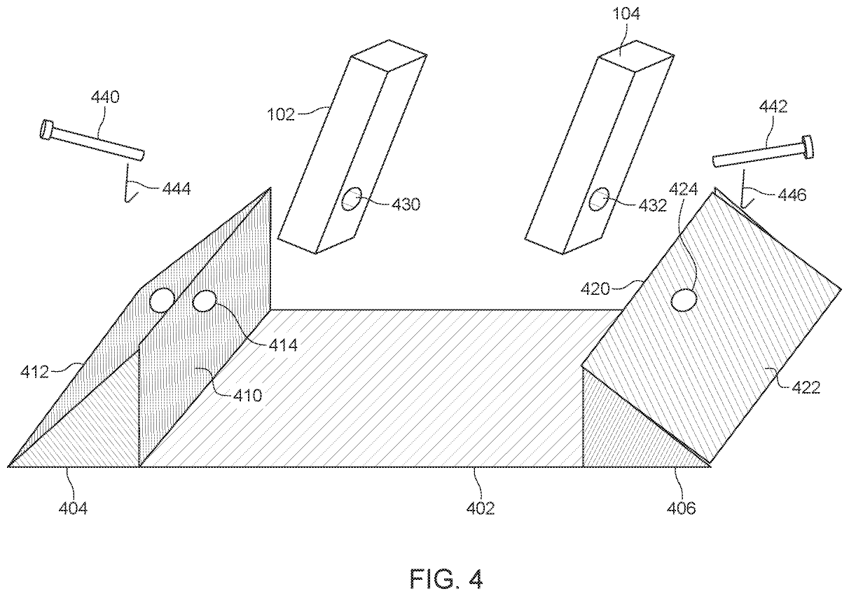

As illustrated in FIG. 4, which is an exploded view, the anti-slip footing 110 includes a base 402, a first side support 404, and a second side support 406. The first side support 404 is formed on one side of base 402, and the second side support 406 is formed at an opposing side of base 402. The first side support 404 and the second side support 406 can be formed having a triangular cross-sectional shape. For example, the first side support 404 can include an inner wall 410, which is approximately perpendicular to the base 402, and a sloped outer wall 412. The second side support 406 can include an inner wall 420, which is approximately perpendicular to the base 402, and a sloped outer wall 422. The anti-slip footing 110 is positioned so that the first rail 102 is adjacent to the inner wall 410 of the first side support 404, and the second rail 104 is adjacent to the inner wall 420 of the second side support 406. The first side support 404 and the second side support 406 inhibit the ladder 100, e.g., the first rail 102 and the second rail 104, from moving and/or sliding laterally. The bottom surface of the base 402 can also be textured to inhibit the base 402 from moving and/or sliding latterly and longitudinally.

The anti-slip footing 110 can be coupled to the first rail 102 and the second rail 104 by a first pin 440 and a second pin 442, respectively. The first pin 440 and the second pin 442 can include a key 444 and a key 446, respectively, that can be inserted to hold the first pin 440 and the second pin 442 or removed to allow the first pin 440 and the second pin 442 to be removed. In some embodiments, the first pin 440 and the second pin 442 can be cotter pins. The first side support 404 can include a pin via (or channel) 414 from the inner wall 410 to the outer wall 412. The first rail 102 can include a pin via (or channel) 430 formed adjacent to the proximal end 114. To couple the first rail 102 to the first side support 404, the first pin 440 can be inserted through the pin via 414 and the pin via 430. The second side support 406 can include a pin via (or channel) 424 from the inner wall 420 to the outer wall 422. The second rail 104 can include a pin via (or channel) 432 formed adjacent to the proximal end 118. To couple the second rail 104 to the second side support 406, the second pin 442 can be inserted through the pin via 424 and the pin via 432.

In embodiments, the anti-slip footing 110 can be removed from the ladder 110 by removing the first pin 440 and the second pin 442. In embodiments, the first pin 440 and second pin 442 can rotate within the vias of the rails and side supports. As such, the anti-slip footing 110 can move relative to the first rail 102 and the second rail 104.

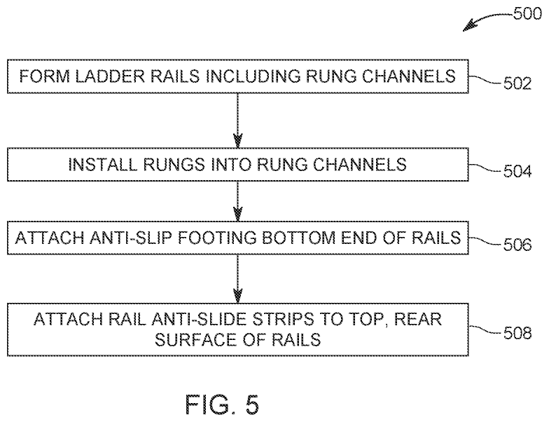

FIG. 5 shows a method 500 of manufacturing the ladder 110, according to embodiments of the present disclosure. In stage 502, the ladder rails, e.g., the first rail 102 and the second rail 104, can be formed, including rung channels. In stage 504, the rungs can be installed into the rung channels. In 506, the anti-slip footing can be formed and installed on the bottom ends of the ladder rails, e.g., the first rail 102 and the second rail 104. In stage 508, the rail anti-slide strips can be attached to top, rear surface of the ladder rails, e.g., the first rail 102 and the second rail 104.

In embodiments, the ladder 100 can be manufactured to have various dimensions based on the type of application or project. For example, the ladder 100 can be manufactured to have the following dimensions: the first rail 102 and the second rail 104 can be formed having a width of approximately 2.0 inches and a depth of approximately 3.0 inches; the first rail 102 and the second rail 104 can be spaced apart approximately 16.0 inches; the first rail 102 and the second rail can be formed having a length of approximately 14.0 feet; the base of the anti-slip footing 110 can have a width of approximately 24.0 and a depth of approximately 8.0 inches; the inner wall 410 of the first side support 404 and the inner wall 420 of the second side support can 406 can be formed to a height of approximately 5 includes; the ladder 100 can be formed having a weight less than approximately 30 pounds; and the ladder 100 can be formed to support of load of approximately 250 pounds.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A ladder, comprising:
a first rail and a second rail spaced apart and parallel to one another;
a plurality of rungs coupled between the first rail and the second rail, wherein each of the plurality of rungs are spaced a distance apart along a length of the first rail and the second rail; and
an anti-slip footing removably coupled to a proximal end of the first rail and a proximal end of the second rail, the anti-slip base comprising:
a base,
a first side support coupled to a first side of the base, and
a second side support coupled to a second side of the base opposite the first side of the base, wherein the first side support and the second side support inhibit the first rail and the second rail, respectively, from sliding laterally and wherein the anti-slip footing is configured to move relative to the first rail and the second rail.

2. The ladder of claim 1, the ladder further comprising:
a first pin configured to removably couple the first side support of the anti-slip footing to the first rail; and
a second pin configured to removably couple the first side support of the anti-slip footing to the first rail.

3. The ladder of claim 2, the ladder further comprising:
a first via formed through the first side support;
a second via formed through the second side support;
a third via formed through first rail; and
a fourth via formed through the second rail, wherein the first pin is inserted through the first and third via, and the second pin is inserted through the second and fourth via.

4. The ladder of claim 1, wherein the first side support of the anti-slip footing comprises:
a first inner wall approximately perpendicular to the base; and
a first side wall slanted at an angle relative to the base, wherein the first rail is positioned adjacent to the first inner wall.

5. The ladder of claim 4, wherein the second side support of the anti-slip footing comprises:
a second inner wall approximately perpendicular to the base; and
a second side wall slanted at an angle relative to the base, wherein the second rail is positioned adjacent to the second inner wall.

6. The ladder of claim 1, a last rung of the plurality of rungs, positioned adjacent to a distal end of the ladder includes a rounded surface.

7. The ladder of claim 1, a penultimate rung of the plurality of rungs, positioned adjacent to a distal end of the ladder includes a rounded surface.

8. The ladder of claim 1, the ladder further comprising:
a first anti-slide strip position on a rear surface of the first rail, adjacent to a distal end of the first rail; and
a second anti-slide strip position on a rear surface of the second rail, adjacent to a distal end of the second rail.

9. The ladder of claim 1, wherein:
the first rail comprises a first rung channel for receiving a first end of a rung from the plurality of rungs, wherein a cross-sectional shape of the first rung channel matches a shape of the first end of the rung; and
the second rail comprises a second rung channel for receiving a second end of the rung from the plurality of rungs, wherein a cross-sectional shape of the second rung channel matches a shape of the second end of the rung.

10. The ladder of claim 9, wherein the cross-sectional shape of the first rung channel and the cross-sectional shape of the second rung channel comprises at least one of a square shape, a round shape, a triangular shape, and a rhombus shape.
